(19) United States
(12) Patent Application Publication
(10) Pub. No.: US 2017/0316527 A1
(43) Pub. Date: Nov. 2, 2017

(54) Distributed Reconciliation Systems and Methods

(71) Applicant: Jon L. Bishop, Winsted, CT (US)

(72) Inventor: Jon L. Bishop, Winsted, CT (US)

(73) Assignee: Countability, LLC, West Hartford, CT (US)

(21) Appl. No.: 15/351,252

(22) Filed: Nov. 14, 2016

Related U.S. Application Data
(60) Provisional application No. 62/254,926, filed on Nov. 13, 2015.

(51) Int. Cl. G06Q 50/20; G06Q 10/10; G06Q 50/26

(52) U.S. Cl. CPC G06Q 50/205; G06Q 10/109; G06Q 50/265

(57) ABSTRACT

A system and methods are provided to allow one or more users to account for all of the individuals in a group of people in order to reconcile or account for the individuals that are present against the individuals that are supposed to be present. In some embodiments, a method may include distributing reconciliation data to client devices of users comprising the steps of: retrieving the registered client devices of the users; retrieving a listing of the students associated with each user; retrieving current student attendance data; determining if each student on listing is in attendance; populating a reconciliation listing with student data of students in attendance; and distributing the reconciliation listing to the client device of the user associated with each user.

### CROSS-REFERENCE TO RELATED APPLICATION

This application claims the benefit of U.S. Provisional Application No. 62/254,926 filed Nov. 13, 2015, the entire contents of which are incorporated by reference herein.

### FIELD OF THE INVENTION

This patent specification relates to the field of distributed reconciliation of individuals. More specifically, this patent specification relates to systems and methods that are configured to allow the reconciliation of individuals to be performed in a distributed manner by two or more users.

### BACKGROUND OF THE INVENTION

In an emergency situation it is often very difficult to account for all of the individuals in a group of people in order to reconcile the individuals that are present against the individuals that are supposed to be present. As the number of individuals that need to be accounted for increases, so does the amount of time and effort needed to accomplish this. This is especially evident with emergency situations that happen at schools. Large groups of students at different locations on campus need to be accounted for as quickly as possible. Currently the only way to reconcile individuals requires paper-based processes. Due to the inherent chaotic nature of emergency situations, it can take as long as twenty-four hours to reconcile the students who were present at a location against the students that were supposed to be present. Unfortunately, the longer it takes to perform the reconciliation, the longer it may take to realize that a student or individual is missing or in need of assistance.

Therefore, a need exists for novel reconciliation systems and methods. A further need exists for novel reconciliation systems and methods that are able to coalesce a plurality of separate distributed reconciliations into a single reconciliation. Finally, a need exists for novel distributed reconciliation systems and methods that are able to create, distribute, and receive reconciliations to a plurality of users.

### SUMMARY OF THE INVENTION

A system and methods are provided to allow one or more users to account for all of the individuals in a group of people in order to reconcile or account for the individuals that are present against the individuals that are supposed to be present. In some embodiments, a method may include distributing reconciliation data to client devices of users. The method may comprise the steps of: retrieving the registered client devices of the users; retrieving a listing of the students associated with each user; retrieving current student attendance data; determining if each student on listing is in attendance; populating a reconciliation listing with student data of students in attendance; and distributing the reconciliation listing to the client device of the user associated with each user.

According to another embodiment consistent with the principles of the invention, a method for coalescing reconciliation data from client devices is provided. In some embodiments, the method may comprise the steps of: receiving distributed reconciliation data comprising reconciliation data on one or more students from a user on a client device; sending the distributed reconciliation data to a server; determining if the students are accounted for from the distributed reconciliation data; populating a master reconciliation listing with data on the accounted for students; and distributing the master reconciliation listing to a registered client device.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a distributed reconciliation system according to various embodiments described herein.

FIG. 2 illustrates a block diagram showing an example of a server which may be used by the system as described in various embodiments herein.

FIG. 3 shows a block diagram illustrating an example of a client device which may be used by the system as described in various embodiments herein.

FIG. 4 depicts a block diagram showing some software rules engines which may be configured to run on a server according to various embodiments described herein.

FIG. 5 illustrates a block diagram showing some software rules engines which may be configured to run on a client device according to various embodiments described herein.

FIG. 6 shows a block diagram of an example of a method for distributing reconciliation data to client devices according to various embodiments described herein.

FIG. 7 depicts a block diagram of an example of a method for coalescing reconciliation data from client devices according to various embodiments described herein.

### DETAILED DESCRIPTION OF THE PREFERRED EMBODIMENTS

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

The term “electronic device” as used herein is a type of electronic device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include; personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include; cell phones, smart phones, tablet computers, laptop computers, wearable computers such as watches, Google Glasses, etc. and the like.

The term “client device” or sometimes “electronic device” or just “device” as used herein is a type of computer generally operated by a person. In some embodiments, a client device is a smart phone or computer configured to receive and transmit data to a server or other electronic device which may be operated locally or in the cloud. Non-limiting examples of client devices include; personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of client devices which are portable and easily carried by a person from one location to another may sometimes be referred to as a “mobile device” or “portable device”. Some non-limiting examples of mobile devices include; cell phones, smart phones, tablet computers, laptop computers, wearable computers such as watches, Google Glasses, etc. and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers, such as client devices, either using wires or wirelessly allowing them to transmit and receive data. Non-limiting examples of data networks may include the internet or wireless networks or (i.e. a “wireless network”) which may include wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New distributed reconciliation systems and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

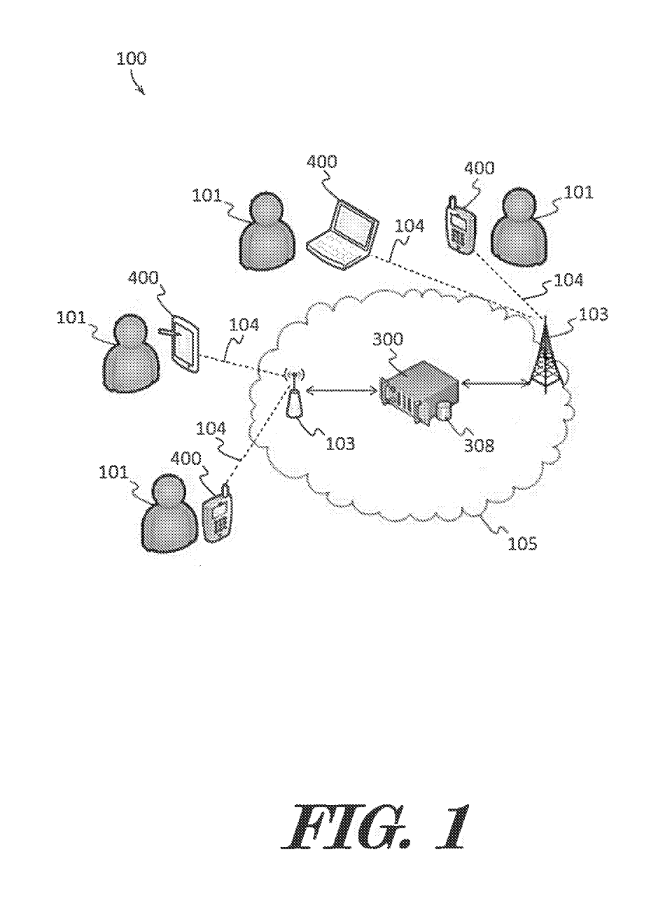

The present invention will now be described by example and through referencing the appended figures representing preferred and alternative embodiments. As perhaps best shown by FIG. 1, an illustrative example of some of the physical components which may comprise a distributed reconciliation system (“the system”) 100 according to some embodiments is presented. The system 100 is configured to facilitate the transfer of data and information between one or more access points 103, client devices 400, and servers 300 over a data network 105. A data store 308 accessible by the server 300 may contain one or more databases. The data may comprise any information that one or more users 101 may desire to input into the system 100 including information on one or more users 101, information requested by one or more users 101, information supplied by one or more users 101, and any other information which a user 101 may desire to input or enter into the system 100. Generally, a user 101 may comprise a person, such as a teacher, teaching assistant, administrator, employer and the like, that is tasked with accounting for one or more individuals, such as students, athletes, musicians, employees, and the like. In some embodiments, the system 100 may be configured to allow one or more users 100 to account for all of the individuals in a group of people in order to reconcile or account for the individuals that are present against the individuals that are supposed to be present.

In this example, the system 100 comprises at least one client device 400 (but preferably more than two client devices 400) configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

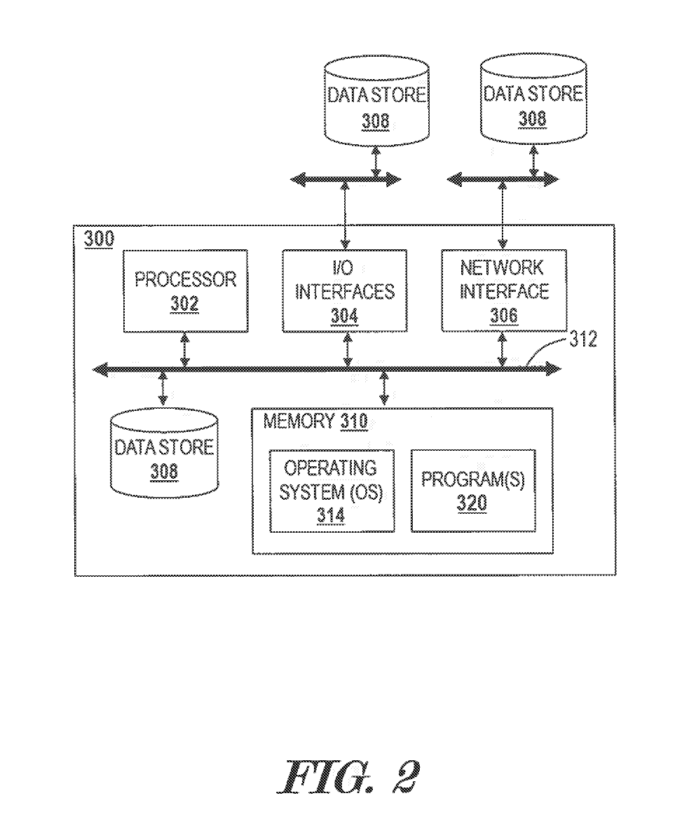

Referring now to FIG. 2, in an exemplary embodiment, a block diagram illustrates a server 300 of which one or more may be used in the system 100 or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

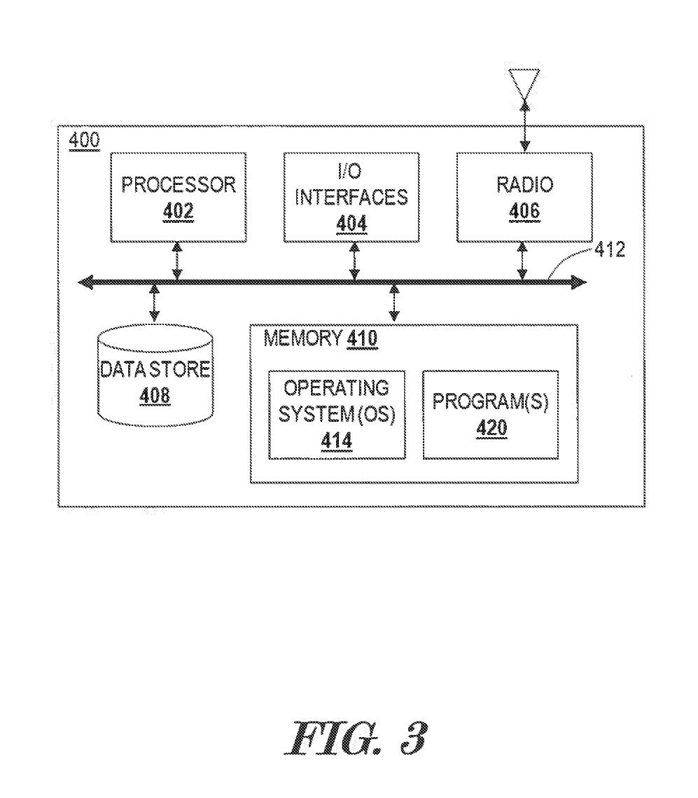

Referring to FIG. 3, in an exemplary embodiment, a block diagram illustrates a client device 400 of which one or more may be used in the system 100 or the like. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications. The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network such as the system 100.

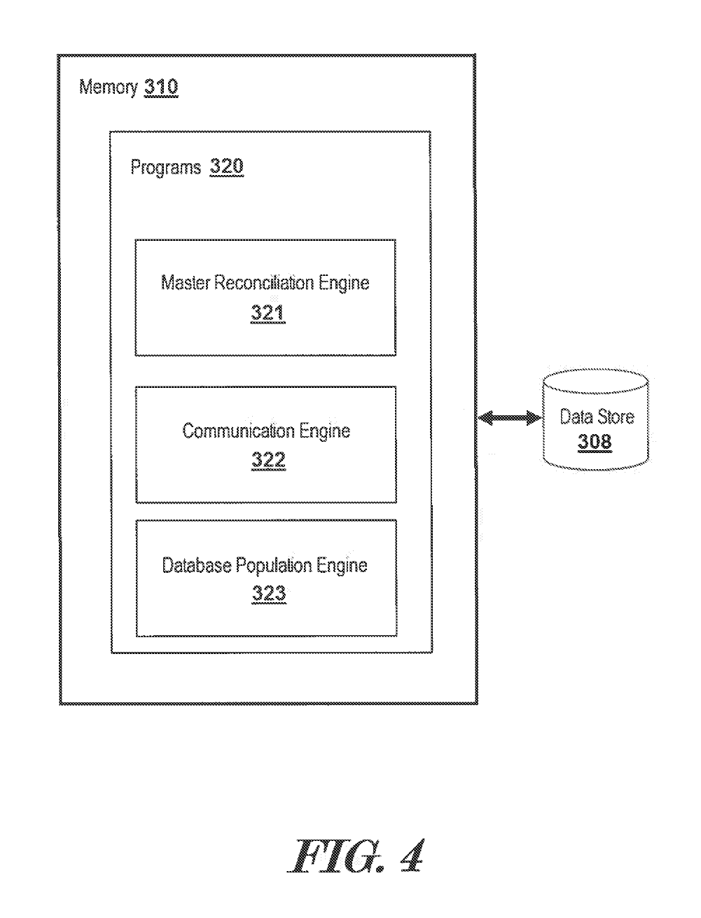

FIG. 4 depicts a block diagram showing some software rules engines which may be found in a system 100 (FIG. 1), and which may optionally be configured to run on a server 300 (FIGS. 1 and 2) according to various embodiments described herein. In some embodiments, one or more servers 300 may be configured to run one or more software rules engines or programs such as a master reconciliation engine 321, communication engine 322, and/or a database population engine 323. In this embodiment, the engines 321, 322, 323, are configured to run on at least one server 300. The server 300 may be in electronic communication with a data store 308 comprising a database, such as a reconciliation database. The engines 321, 322, 323, may read, write, or otherwise access data in the database of the data store 308. Additionally, data may be sent and received to and from one or more client devices 400 (FIGS. 1 and 3) which may be in wired and/or wireless electronic communication with a server 300 through a network 105. In other embodiments, a master reconciliation engine 321, communication engine 322, and/or a database population engine 323 may be configured to run on a client device 400 and/or server 300 with data transferred to and from one or more servers 300 in communication with a data store 308 through a network 105. In still further embodiments, a server 300 and a client device 400 may be configured to run a master reconciliation engine 321, communication engine 322, and/or a database population engine 323.

In some embodiments, the system 100 may comprise a database, such as a reconciliation database, stored on a data store 308 accessible to a master reconciliation engine 321, communication engine 322, and/or a database population engine 323. A reconciliation database may comprise data and information on one or more users 101 and individuals associated with an institution, such as school, school system, human resource department, campus, church, daycare, and the like. For example, data in a reconciliation database (reconciliation data) associated with a school may include registered users 100 and their respective client devices 400, all students associated with the school, all users 101 associated with the school, time periods when each student is being supervised by a specific user 101, all students currently in attendance at the school, which students are absent, which students have gone home early, which classroom each student is scheduled to be in throughout the day, all students currently in attendance at the school and accounted for, all students currently in attendance at the school and not accounted for, current emergency event status of the school, the school's emergency procedure documents, student with medical problems, student with special needs, or any other relevant data.

The communication engine 322 may be configured to govern electronic communication between servers 300, third party databases, and client devices 400. Data from servers 300, third party databases, and client devices 400 may be received by the communication engine 322 which may then electronically communicate the data to the master reconciliation engine 321 and database population engine 323. Likewise, data from the master reconciliation engine 321 and database population engine 323 may be received by the communication engine 322 which may then electronically communicate the data to servers 300, third party databases, and client devices 400. In some embodiments, the communication engine 322 may govern the electronic communication by initiating, maintaining, reestablishing, and terminating electronic communication between the server 300 and one or more third party databases, client devices 400, and other servers 300. In further embodiments, the communication engine 322 may control the network interface 306 (FIG. 2) of the server 300 to send and receive data to and from one or more third party databases, client devices 400, and other servers 300 through a network connection 104 (FIG. 1) over a network 105 (FIG. 1).

The database population engine 323 may be configured to retrieve data from the communication engine 322, such as data from one or more databases or data stores and to write this data to the reconciliation database on the data store 308 of the system 100. The communication engine 322 may govern the electronic communication between the server 300 and one or more databases or data stores to allow the database population engine 323 to retrieve data from one or more databases or data stores and to write this data to the reconciliation database on the data store 308. This data which may be used to form a reconciliation database may include current students, teacher logins, student IDs, class schedules, reports, emergency procedures, which students have left early, which students are absent, students with medical problems, messages, emergency reports, substitute teachers present, broadcast messages across schools, school administrators, and any other data.

In some embodiments, the communication engine 322 may govern the electronic communication between the server 300 and a third party database to allow the database population engine 323 to retrieve data and information from the third party database. For example, the communication engine 322 may govern the electronic communication between the server 300 of the system 100 and a server 300 operated by PowerSchool® (powerschool.com) a student information system in North America which maintains one or more databases with data on each subscribing school's current students, teacher logins, student IDs, class schedules, and any additional information to which the schools provide access. Once communication is established between the server 300 and a PowerSchool® server 300, the database population engine 323 may retrieve data and information from the PowerSchool® database.

In still further embodiments, the communication engine 322 may govern the electronic communication between the server 300 of the system 100 and a database maintained by an institution, such as a school, school system, human resource department, and the like, to allow the database population engine 323 to retrieve data and information from the database. For example, the communication engine 322 may govern the electronic communication between the server 300 and a server 300 operated by a school system. The school system server 300 may allow access to a data store 308 with a database that comprises data such a current students, teacher logins, student IDs, class schedules, and any additional information to which the schools provide. Once communication is established between the server 300 and the school system server 300, the database population engine 323 may retrieve data and information from the database maintained by an institution.

The communication engine 322 may govern the electronic communication between the server 300 and a database maintained by an institution to allow the database population engine 323 to regularly retrieve data and information from the database. The data may be refreshed regularly, such as at desired time intervals or periods, throughout the day by the database population module 322 to reflect current information on individuals and users 101 associated with an institution. For example, at an institution such as a school, information on individuals and users 101 associated with the school may include which students are absent, which students have gone home early, which class each student is scheduled to be in throughout the day, which student is to be under the care or supervision of which teacher or administrator throughout the school day, and other like data.

The master reconciliation engine 321 may send and retrieve data to and from the reconciliation database, and the master reconciliation engine 321 may also send reconciliation data to one or more client devices 400 and to receive and to coalesce reconciliation data received from the client devices 400 into the reconciliation database. In some embodiments, the reconciliation engine 321 may determine which individuals are present at an institution and determine which user 101 is responsible for supervising one or more of the individuals using data from the reconciliation database. The master reconciliation engine 321 may create a distributed reconciliation listing with data on one or more individuals and then send the listing to the communication engine 322 which may electronically communicate the listing to the client device 400 of the user 101 supervising the individuals. In further embodiments, the communication engine 322 may receive distributed reconciliation listings from the client devices 400 of users 101 with data on one or more individuals and then send the listings to the master reconciliation engine 321. The master reconciliation engine 321 may then coalesce the distributed reconciliation listings into a single master reconciliation listing and/or store the data from the reconciliation listings in the reconciliation database. In further embodiments, the master reconciliation engine 321 may receive a text, audio, and/or video message which may be input into an I/O interface 304 of the server 300 by the user 101. The master reconciliation engine 321 may send the message to the distributed reconciliation engine 421 of one or more client devices 400.

In some embodiments, a master reconciliation listing may comprise a listing with data on all of the individuals which are currently present at an institution and which users 101 are currently responsible for supervising the individuals. This data may optionally include a picture of one or more of the individuals and users 101, other identifying information of individuals and users 101, special needs of the individuals and users 101, medical conditions of the individuals and users 101, emergency contact information for the individuals and users 101, and/or any other information. The master reconciliation listing may be maintained by the master reconciliation engine 321 in a database on a data store 308 accessible by the server 300 of the system 100.

In some embodiments, a distributed reconciliation listing may comprise a listing with data on one or more individuals which are currently present at an institution and which user 101 is currently responsible for supervising the individuals. This data may optionally include a picture of one or more of the individuals and users 101, other identifying information of individuals and users 101, special needs of the individuals and users 101, medical conditions of the individuals and users 101, emergency contact information for the individuals and users 101, and/or any other information. The distributed reconciliation listing may be sent to the client device 400 of the user 101 that is responsible for supervising the individuals. Data on the individuals may be input into the client device, optionally by the user 101, and the inputted data may be sent to the master reconciliation engine 321. A distributed reconciliation listing may be created by the master reconciliation engine 321 using data from the master reconciliation listing and then sent to the client device 400 of a user 101. Data may be input into the client device 400 of the user 101, optionally by the user 101, and the inputted data may be sent to the master reconciliation engine 321 to be added to the master reconciliation listing. In this manner, a plurality of distributed reconciliation listings may be created by the master reconciliation engine 321 and then sent to the client device 400 of a plurality of users 101. Data may be input into one or more of the client devices 400 and the inputted data may be sent to the master reconciliation engine 321 to be added to the master reconciliation listing.

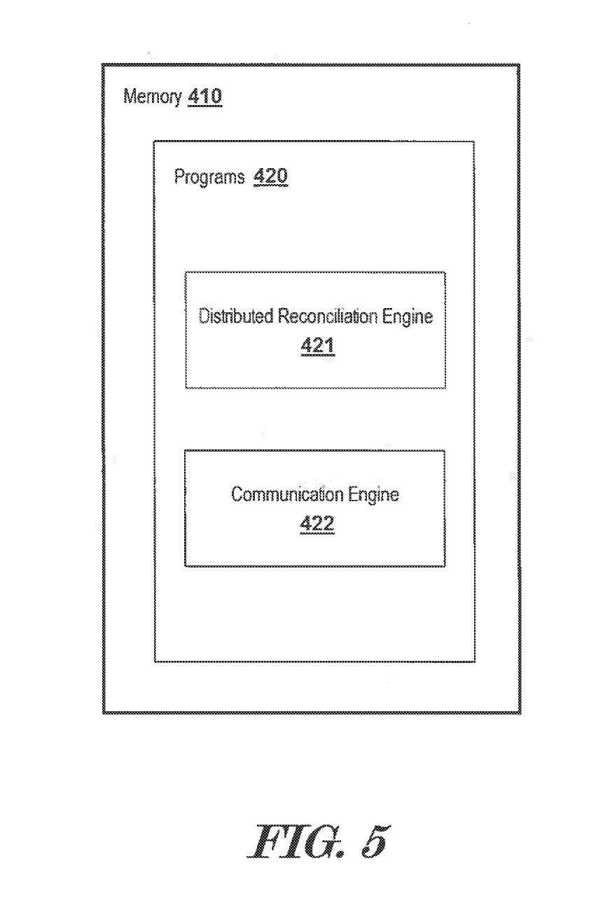

FIG. 5 illustrates a block diagram showing some software rules engines which may be found in a system 100 (FIG. 1) and which may optionally be configured to run on a client device 400 (FIGS. 1 and 3) according to various embodiments described herein. In some embodiments, one or more client devices 400 may be in communication with a server 300 and the client devices 400 may be configured to run one or more software rules engines or programs such as a distributed reconciliation engine 421 and/or communication engine 422. In other embodiments, a distributed reconciliation engine 421 and/or a communication engine 422 may be configured to run on a client device 400 and/or server 300 with data transferred to and from one or more servers 300 in communication with a data store 308 through a network 105. In still further embodiments, a server 300 and a client device 400 may be configured to run a distributed reconciliation engine 421 and/or a communication engine 422.

The communication engine 422 may be similar in function to a communication engine 322 (FIG. 4) of a server 300 (FIGS. 1 and 2) and may be configured to govern electronic communication between the client device 400 which is running the communication engine 422 and a server 300 of the system 100 and/or one or more other client devices 400. Data from servers 300 and other client devices 400 may be received by the communication engine 422 which may then electronically communicate the data to the distributed reconciliation engine 421. Likewise, data from the distributed reconciliation engine 421 may be received by the communication engine 422 which may then electronically communicate the data to servers 300 and/or other client devices 400. In some embodiments, the communication engine 422 may govern the electronic communication by initiating, maintaining, reestablishing, and terminating electronic communication between the client device 400 and a server 300 of the system 100 and/or one or more other client devices 400. In further embodiments, the communication engine 422 may control the radio 406 (FIG. 3) or other network interface of the client device 400 to send and receive data to and from one or servers 300 and/or client devices 400 of the system 100 through a network connection 104 (FIG. 1) over a network 105 (FIG. 1).

The distributed reconciliation engine 421 may send and receive data to and from the master reconciliation engine 321 through the communication engine 422. The distributed reconciliation engine 421 may receive data such as a distributed reconciliation listing, emergency procedure documents, and any other data discussed herein. The distributed reconciliation engine 421 may then send this data to an I/O interface 404 (FIG. 3), such as a touch screen display or other display device, of a client device 400 of a user 101. In some embodiments, the user 101 may input data through a touch screen display interface 404, a keyboard interface 404, a camera interface 404, an RFID interface 404, or any other type of interface 404 of the client device 400. In further embodiments, the distributed reconciliation engine 421 may activate a camera interface 404, an RFID interface 404, or any other type of interface 404 of the client device 400, and then receive data from the I/O interface 404. Data input by a user 101 or by an I/O interface 404 may comprise data indicating that the user 101 is accounting for or affirming that the student is present with the user 101. Reconciliation data may include data input by a user 101 or by an I/O interface 404 indicating that the user 101 is accounting for or affirming that the student is present with the user 101. The distributed reconciliation engine 421 may receive this data and then direct the communication engine 422 to send the data to the master reconciliation engine 321 via the communication engine 322. In further embodiments, the distributed reconciliation engine 421 may receive a text, audio, and/or video message which may be input into an I/O interface 404 by the user 101. The distributed reconciliation engine 421 may send the message to the master reconciliation engine 321 and the master reconciliation engine 321 may send the message to one or more other client devices 400.

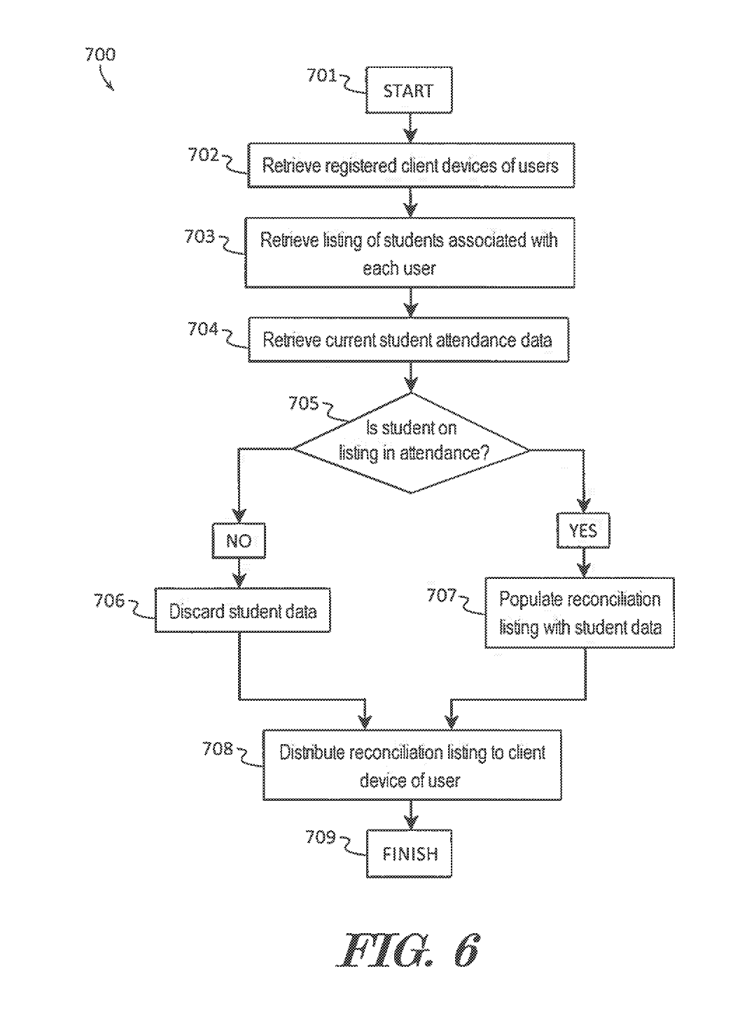

FIG. 6 shows a block diagram of an example of a method for distributing reconciliation data to client devices (“the method”) 700 according to various embodiments described herein. The method 700 may be used to send reconciliation data which may be included in a reconciliation listing, such as a distributed reconciliation listing, to the client device 400 of a user 101 at an institution. The data may include information on one or more individuals that are determined to be under the supervision of the user 101. In this example the institution is a school, the users 101 may be teachers, professors, substitute teachers, teacher assistants, administrators, emergency responders, safety officers, or any other person that may be an agent of the school, and the individuals may be students or anyone under the care of the school. In other embodiments, an institution may include a college campus, other educational facility, place of employment, daycare center, hospital, other medical or treatment facility, government facility, religious facility, or any other facility with one or more individuals and users 101. A user 101 may comprise a person, such as a caretaker, employer, healthcare worker, religious worker, or anyone else that is tasked with accounting for one or more individuals. An individual may include students, patients, patrons, athletes, musicians, employees, parishioners, invalids, wards, and anyone else that may be supervised by a user 101.

In some embodiments, the method 700 may start 701 and the registered client devices 400 of users 100 may be retrieved in step 702. In some embodiments, the database population engine 323 may retrieve data, such as a list of all the teacher identifications, teacher client devices 400, and other data from a third party database such as Powerschool® and the like or other database maintained by the school. In further embodiments, the registered client devices 400 of users 101 such as teachers, administrators, and other like users 101 may be retrieved from the reconciliation database on a data store 308 by the database population engine 323. This data may be populated into the reconciliation database by the database population engine 323. The database population engine 323 may retrieve information, such as the contact information of the client devices 400, which may be used by the communication engine 322 to communicate with the electronic devices 400. A client device 400 may be registered by signing into the system 100 with credentials such as a user identification and password to ensure that the users 101 are currently in a position of supervision at the institution and/or to prevent unauthorized access to data.

In step 703, the listing of students associated with each user 101 may be retrieved. In some embodiments, the database population engine 323 may retrieve data, such as a list of all the students currently enrolled at the school, class schedules, student identifications, student medical problems, student special needs, and other data from a third party database such as Powerschool® and the like or other database maintained by the school. This data may be populated into the reconciliation database by the database population engine 323 and may be used to determine, in conjunction with the time of day, the listing of the students which are currently associated or under the supervision of each teacher of user 101.

In step 704, the current student attendance data may be retrieved. In some embodiments, the database population engine 323 may retrieve data, such as a list of all the students absent from the school, all the students which have left or are leaving early from the school and other attendance data from a third party database such as Powerschool® and the like or other database maintained by the school. This data may be populated into the reconciliation database by the database population engine 323.

In some embodiments, steps 702-704 may be performed sequentially, while in other embodiments, steps 702-704 may be performed in any order and even simultaneously by the database population engine 323. The information retrieved in steps 702-704 by the database population engine 323 may be provided to the master reconciliation engine 321. Next in decision block 705, the master reconciliation engine 321 may determine in conjunction with the time of day, using the data retrieved in steps 702-704, if each student enrolled at the school is currently present or in attendance at the school. If a student enrolled at the school is not currently present or in attendance at the school, the method 700 may continue to step 706 and the student data may optionally be discarded by the master reconciliation engine 321. If a student enrolled at the school is currently present or in attendance at the school, the method 700 may continue to step 707 and the student data may be populated into a reconciliation listing, such as a master reconciliation listing and/or distributed reconciliation listing by the master reconciliation engine 321. Steps 706 and 707 may be repeated until each student enrolled at the school is determined to be currently present or in attendance at the school.

Next in step 708, the reconciliation listing may be distributed to the client device 400 of a user 101. In further embodiments, the reconciliation listing may be a distributed reconciliation listing which may be created by the master reconciliation engine 321. By comparing the listing of current students in attendance to the listing of students associated with each user 101, the master reconciliation engine 321 may create a distributed reconciliation listing for each teacher or user 101 comprising reconciliation data on the students that are currently under the supervision of each teacher. The distributed reconciliation listing may then be sent to the client device 400 of each teacher or user 101. In further embodiments, the reconciliation data may include all students currently in attendance at the school and accounted for, current emergency event status of the school, the school's emergency procedure documents, student with medical problems, student with special needs, or any other relevant data. Once a distributed reconciliation listing has been sent to each registered client device 400 of the users currently supervising students, the method 700 may finish 709.

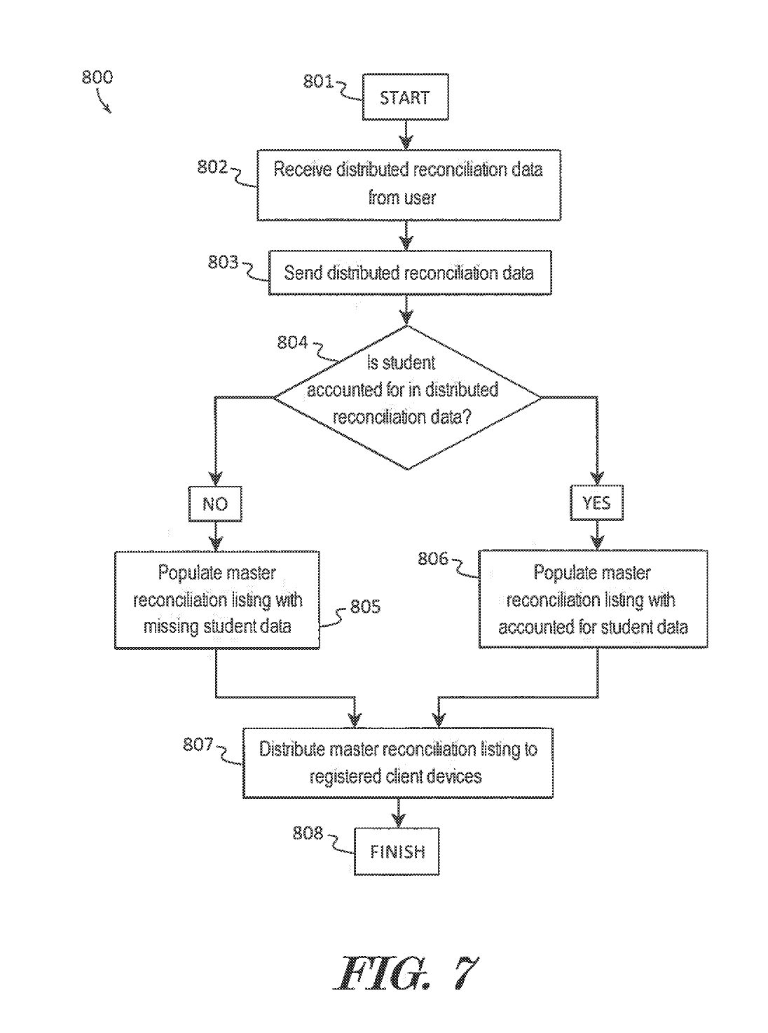

FIG. 7 depicts a block diagram of an example of a method for coalescing reconciliation data from client devices (“the method”) 800 according to various embodiments described herein. The method 800 may be used to coalesce data received from client devices 400 registered with the system 100 which were sent a distributed reconciliation listing into a master reconciliation listing. The master reconciliation listing may be stored in a reconciliation database on a data store 308 of the system 100 and may be distributed to one or more client devices 400 such as to a client device 400 of an administrator user 101 or emergency responder user 101. In this example the institution is a school, the users 101 may be teachers, professor, substitute teachers, teacher assistants, administrators, emergency responders, or any other person that may be an agent of the school, and the individuals may be students or anyone under the care of the school. In other embodiments, an institution may include a college campus, other educational facility, place of employment, daycare, hospital, other medical or treatment facility, government facility, religious facility, or any other facility with one or more individuals and users 101. A user 101 may comprise a person, such as a caretaker, employer, healthcare worker, religious worker, or anyone else that is tasked with accounting for one or more individuals. An individual may include athletes, musicians, employees, parishioners, invalids, wards, and anyone else that may be supervised by a user 101.

In some embodiments, the method 800 may start 801 and distributed reconciliation data may be received from a user 101 such as a teacher in step 802. In further embodiments, the teacher may input reconciliation data into an I/O interface, such as a touch screen interface, of a registered client device 400. The reconciliation data may include accounting data on one or more students that the teacher is supervising, and the data may include information, such as the student is present or accounted for by the teacher, the student is not present or accounted for by the teacher, the student needs medical assistance, the teacher needs assistance, another user 101 is present or accounted for by the teacher, another user 101 is not present or accounted for by the teacher, and any other like accounting information. Step 802 may be performed by each registered user on their respective client device 400 and the data may be received by the distributed reconciliation engine 421 on each client device 400 of each teacher user 101. In further embodiments, the distributed reconciliation engine 421 may activate a camera interface 404, an RFID interface 404, or any other type of interface 404 of the client device 400, and then receive data from the I/O interface 404.

In step 803, the distributed reconciliation data may be sent to the master reconciliation engine 321 of the server 300 of the system 100. In some embodiments, the distributed reconciliation engine 421 on the client device 400 of the teacher user 101 may send the distributed reconciliation data via the communication engine 422, to the communication engine 322 which may communicate the data to the master reconciliation engine 321. Step 803 may be performed by the distributed reconciliation engine 421 and communication engine 422 on the client device 400 of each user 101.

Next in decision block 804, the master reconciliation engine 321 may determine if each student that is currently present at the school is accounted for in the received distributed reconciliation data. In some embodiments, the master reconciliation engine 321 may receive distributed reconciliation data from one or more registered client devices 400. If a student is not accounted for in the received distributed reconciliation data or if no data on a student is received the master reconciliation engine 321 may create or populate a master reconciliation listing with data of the missing student in step 805. If a student is accounted for in the received distributed reconciliation data the master reconciliation engine 321 may create or populate a master reconciliation listing with data of the accounted for student in step 806. Steps 805-806 may be repeated until all the reconciliation data received by the master reconciliation engine 321 is processed and coalesced into a master reconciliation listing. Received reconciliation data and the master reconciliation listing may be stored in the reconciliation database on the data store 308 of the system by the master reconciliation engine 321 or the database population engine 323.

Next in step 807, the master reconciliation listing may be distributed to one or more client devices 400 via the communication engine 322. In some embodiments, the master reconciliation listing may be communicated to the communication engine 322 and distributed to one or more client devices 400 via the communication engine 322. In further embodiments, the master reconciliation listing may be retrieved from the reconciliation database by the database population engine 323 and distributed to one or more client devices 400 via the communication engine 322. Once the master reconciliation listing has been distributed to one or more client devices 400, the method 800 may finish 808.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or wifi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and wifi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for accounting for a number of individuals in a group of persons, the method comprising:
generating a start signal from a computer server to a plurality of user client devices
receive confirmation at server of connection of user client device to server
retrieve list of persons associated with or assigned to each user;
retrieve daily attendance data from server;
determine, using a computer processor, which persons are not present at the location and forward attendance data to user client device; and
receive response from user client device concerning which persons are accounted for and which persons are missing

2. A method according to claim 1 wherein the server generates a list of missing persons.

3. A method according to claim 2, wherein the list of missing persons is forwarded to all user client devices to enable location or identification of missing persons by other users.

4. A method according to claim 3, wherein the server forwards instructions to at least one user client device.

5. A method according to claim 2, wherein the server connects to a public address system and generates an announcement including the name of each missing person, requesting that that person report to an appropriate location or authority.

6. A digital system to account for a number of students in attendance at a school, the system comprising:
an attendance database of persons present in the school, including students, faculty, staff, and visitors, the database having information on each person's location on site to enable administrators and faculty to locate and account for each person present in the school;
a plurality of registered client devices of users, the client device having an individual user or owner associated therewith, and capable of wireless communication with the digital system;
a computer including at least one processor having computer instructions, wherein the computer instructions comprise:
instructions to retrieve a listing of students associated with each user;
instructions to retrieve current student attendance data from the attendance database;
instructions to communicate and retrieve a signal from the registered client devices of users:
instructions to retrieve a listing of students associated with each user;
instructions to compare attendance data with the listing of students having a registered device to generate a list of present students;
instructions to forward the list of present students to the client device of the user; and
instructions to identify students in attendance who are missing from the list of students in attendance.

7. A method for coalescing reconciliation data from a plurality of client devices, the method comprising:
receiving distributed reconciliation data pertaining to one or more students from a user on a client device:
sending the distributed reconciliation data to a server;
determining if a student is accounted for in distributed reconciliation data;
identifying students accounted for and students missing from students included in distributed reconciliation data;
populating a master student listing with present and missing student data; and
distributing master reconciliation list including present and missing students to registered client devices.

8. A method according to claim 7 wherein a registered client device can report a student identified as missing.
